(19) United States
(12) Patent Application Publication
(10) Pub. No.: US 2016/0103758 A1
(43) Pub. Date: Apr. 14, 2016

(54) ONLINE PRODUCT TESTING USING BUCKET TESTS

(71) Applicant: Yahoo! Inc., Sunnyvale, CA (US)

(72) Inventors: Zhenyu Zhao, Sunnyvale, CA (US); Flavio T.P. Oliveira, San Francisco, CA (US); Maria Stone, Pacifica, CA (US); Miao Chen, Sunnyvale, CA (US); Shalu Pandey, Santa Clara, CA (US); Kshitiz Tripathi, North San Jose, CA (US)

(73) Assignee: Yahoo! Inc., Sunnyvale, CA (US)

(21) Appl. No.: 14/509,741

(22) Filed: Oct. 8, 2014

(51) Int. Cl. G06F 11/36; G06F 9/445

(52) U.S. Cl. CPC G06F 11/3664; G06F 11/3672; G06F 11/3616; G06F 8/65

(57) ABSTRACT

The technologies described herein use a statistical test to determine whether differences between data sets of buckets in a bucket test, such as differences between averages of two buckets (e.g., differences between means of two buckets), are directionally larger than a predetermined or preset minimum threshold value. The statistical test may also provide an extension to specify the minimum threshold value as a percentage. Also, described herein are techniques for estimating different control variables of a bucket test, such as estimating minimum bucket size to provide sufficient statistical power with use of the minimum threshold value.

### BACKGROUND

This application relates to online product testing using bucket tests.

Experimental data regarding online products (such as mobile applications and websites) can be analyzed using standard statistical tests focused on detecting differences between a product with and without updates. For example, a control version of an online product and a test version of the product can be bucket tested to determine whether a difference between the versions is a non-zero value. Product teams may also be interested in knowing if the difference between the two versions is at least a certain magnitude. Standard tests, such as standard two-sided and one-sided tests, may fall short of providing such information. For example, a very small and unimportant difference can still achieve significant a non-zero result for standard tests, ignoring the fact that the difference may be too small to claim success in real business use cases.

The standard techniques of bucket testing, such as a standard one-sided test and a standard two-sided test, are helpful for testing online product updates but may not be well adapted to the complexities that arise in modern online products (such as the complexities in updates to social networking websites, large scale blogs, online multimedia hosting, cloud computing services, software as a service, news websites, retail and ecommerce websites, online ad markets, unified online advertising marketplaces, online email and calendaring services, search engines, online maps, and web portals). There is, therefore, a set of engineering problems to be solved in order to provide testing of online product updates optimally. Such solutions could also simplify optimization of online product updates and automation of the updates.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example online product test system that can provide bucket testing of online product updates.

FIG. 2 illustrates displayed ad items and content items of example screens of example online products rendered by client-side applications associated with the information system illustrated in FIG. 1.

FIG. 3 illustrates example operations performed by a system (such as the system in FIG. 1), which can provide bucket testing of online product updates.

FIG. 4 illustrates a graphical user interface for setting parameters of a bucket test, such as a bucket test executed at 320 of FIG. 3.

FIG. 5 illustrates a block diagram of an example electronic device, such as a server, that can implement aspects of and related to an example product testing system, such as a bucket testing system of the product testing server 116.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### OVERVIEW

The technologies described herein use a statistical test to determine whether differences between data sets of buckets in a bucket test, such as differences between averages of two buckets (e.g., differences between means of two buckets), are directionally larger than a predetermined or preset minimum threshold value. The statistical test may also provide an extension to specify the minimum threshold value as a percentage. Also, described herein are techniques for estimating different control variables of a bucket test, such as minimum bucket size to provide sufficient statistical power with use of the minimum threshold value.

The statistical test may be or include a bucket test, such as an A/B test, for testing a new version of an online product against its current version. An A/B test is a type of bucket test for a randomized experiment with two variants, A and B, which are the control and test variants in the experiment. A goal of such a test is to identify changes to an online product that increases or optimizes a desired metric, such as a desired impression rate or click-through rate. In addition, based on a different statistical test type, a corresponding sample size calculation algorithm will be used for determining the number of users in each bucket needed for achieving a target statistical power.

Some examples of the technologies described herein may include a statistical technique to test if a difference between two buckets in a bucket test is directionally greater than a pre-specified magnitude (e.g., the minimum threshold value). Bucket tests may be analyzed using statistical tests that measure if the difference between two buckets is significantly different from zero. In these examples, where a pre-experiment hypothesis exists for the direction of the difference, a one-sided test may be used. Where a pre-experiment hypothesis does not exist, a two-sided test may be used. However, product teams are typically interested in knowing whether a new version of an online product should lead to an improvement over the current version that is greater than a certain magnitude and not simply greater than zero. Given this interest, variants of a one-sided test are described herein that provide such information.

Additionally, some examples may include methods for deriving sample sizes apt for the aforementioned tests. Sample size (e.g., bucket size) can have a significant effect on the outcome of these tests. On one hand, a large enough sample size should be used to provide sufficient statistical power from the test; on the other hand, product teams should not unnecessarily expose users (such as customers) to test versions of a product, so limiting exposure to the test is an important consideration.

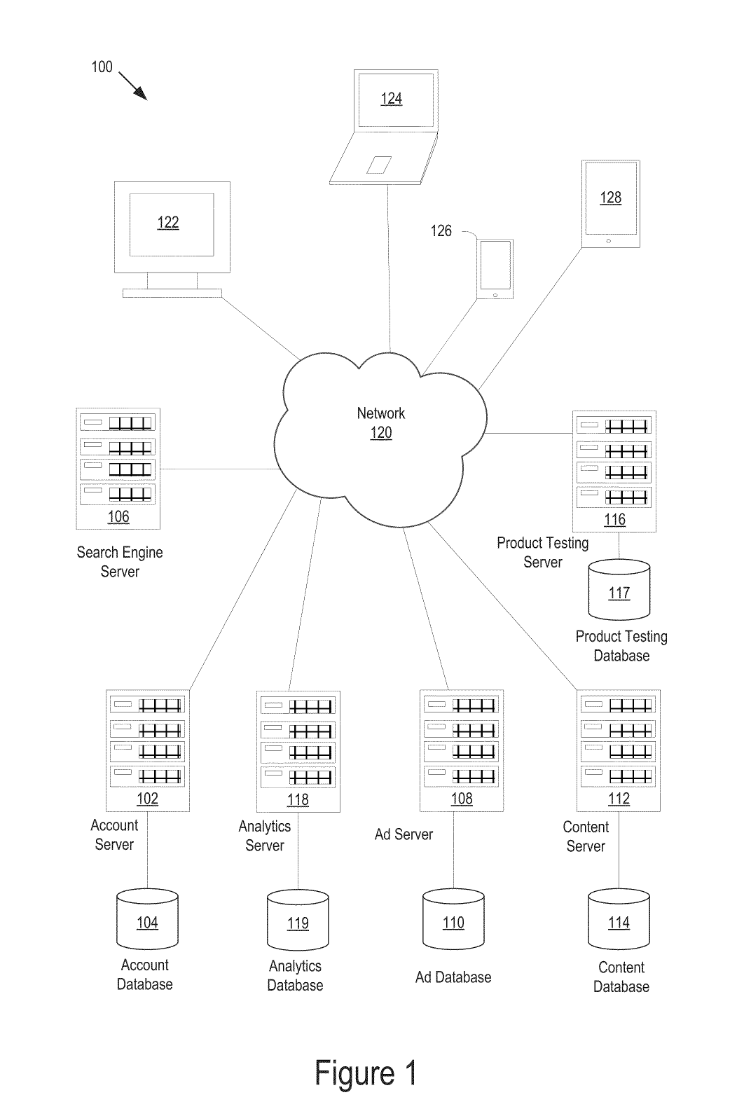

For the purpose of illustration, the detailed description herein will repeatedly refer back to an example of a bucket test for testing an increase in size of a search box on a webpage with a goal of increasing a number of searches originating on the webpage. A product team may consider launching such a change on a publically available product if the amount of searches originating on the webpage increases by a preset or predetermined minimum amount (such as 0.3%). Such an amount may be considered with respect to the revenue impact associated with it. In examples, the minimum amount may be predetermined according to product team criteria or analytics, such as analytics determined and stored by the analytics server 118 and database 119 illustrated in FIG. 1.

Additionally, in some examples, product updates may be launched according to results of the aforementioned tests. Referring to the previous example, if the change to the search box does not provide a lift greater than 0.3% in search traffic, the team may discard the update. Providing such a test result may only be possible by utilizing the minimum amount of difference between the two buckets. As mentioned, a one-sided test with a minimum difference can be used by the technologies described herein, and such a test may provide sufficient results. For simplicity, in this disclosure some of the example techniques assume equal standard deviation in test control buckets.

### DESCRIPTION OF THE DRAWINGS

FIG. 1 illustrates a block diagram of an example information system that includes example devices of a network that can communicatively couple with an example online product test system that can provide bucket testing of online product updates. The information system 100 in the example of FIG. 1 includes an account server 102, an account database 104, a search engine server 106, an ad server 108, an ad database 110, a content database 114, a content server 112, a product testing server 116, a product testing database 117, an analytics server 118, and an analytics database 119. The aforementioned servers and databases can be communicatively coupled over a network 120. The network 120 may be a computer network. The aforementioned servers may each be one or more server computers.

The information system 100 may be accessible over the network 120 by provider devices (such as ad provider devices and/or online product provider devices) and audience devices, which may be desktop computers (such as device 122), laptop computers (such as device 124), smartphones (such as device 126), and tablet computers (such as device 128). An audience device can be a user device that presents online products, such as a device that presents online properties, such as web pages, to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement the online properties and other communications sent over the network to audience devices. The online information system can be deployed and operated by an online services provider, such as Yahoo! Inc.

The account server 102 stores account information for account holders, such as advertisers and product providers. The account server 102 is in data communication with the account database 104. Account information may include database records associated with each respective account holder. Suitable information may be stored, maintained, updated and read from the account database 104 by the account server 102. Examples include account holder identification information, holder security information, such as passwords and other security credentials, account balance information, information related to content associated with their ads or products, and user interactions associated with their ads or products.

The account server 102 may provide an account holder front end to simplify the process of accessing the account information of the account holder. The front end may be a program, application, or software routine that forms a user interface. In a particular example, the front end is accessible as a website with electronic properties that an accessing account holder may view on a client device, such as one of the devices 122-128, when logged on. The holder may view and edit account data and product or ad data, using the front end. After editing the data, the data may then be saved to the account database 104.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106. For example, a query entered into a query entry box can be communicated to the search engine server 106. The search engine server 106 locates matching information using a suitable protocol or algorithm and returns information to the audience client device, such as in the form of ads or content.

The search engine server 106 may be designed to help users and potential audience members find information located on the Internet or an intranet. In an example, the search engine server 106 may also provide to the audience client device over the network 120 an electronic property, such as a web page, with content, including search results, information matching the context of a user inquiry, links to other network destinations, or information and files of information of interest to a user operating the audience client device, as well as a stream or web page of content items and advertisement items selected for display to the user. This information provided by the search engine server 106 may be logged, and such logs may be communicated to the analytics server 118 for processing and analysis. Besides this information, any data outputted by processes of the servers of FIG. 1 may also be logged, and such logs can be communicated to the analytics server 118 for further processing and analysis. Once processed into corresponding analytics data, the analytics data can be stored in the analytics database 119 and communicated to the product testing server 116. At the product testing server 116, the analytics data (i.e., analytics) can be used as input for determining the minimum threshold value for bucket testing.

The search engine server 106 may enable a device, such as a provider client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 may be one or more servers. Alternatively, the ad server 108 may be a computer program, instructions, and/or software code stored on a computer-readable storage medium that runs on one or more processors of one or more servers. The ad server 108 operates to serve advertisements to audience devices. An advertisement may include text data, graphic data, image data, video data, or audio data. Advertisements may also include data defining advertisement information that may be of interest to a user of an audience device. The advertisements may also include respective audience targeting information and/or ad campaign information. An advertisement may further include data defining links to other online properties reachable through the network 120. The aforementioned audience targeting information and the other data associated an ad may be logged in data logs.

For online service providers (a type of online product provider), advertisements may be displayed on electronic properties resulting from a user-defined search based, at least in part, upon search terms. Also, advertising may be beneficial and/or relevant to various audiences, which may be grouped by demographic and/or psychographic. A variety of techniques have been developed to determine audience groups and to subsequently target relevant advertising to members of such groups. Group data and individual user's interests and intentions along with targeting data related to campaigns may be may be logged in data logs. As mentioned, one approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. Similarly, the aforementioned profile-type targeting data may be logged in data logs. Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs.

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the product testing server 116, the analytics server 118, and/or the account server 102. Ad items and ad information, such as pricing, can be logged in data logs.

The content server 112 may access information about content items either from the content database 114 or from another location accessible over the network 120. The content server 112 communicates data defining content items and other information to devices over the network 120. The information about content items may also include content data and other information communicated by a content provider operating a content provider device. A content provider operating a content provider device may access the content server 112 over the network 120 to access information. This access may be for developing content items, editing content items, deleting content items, setting and adjusting bid amounts and other activities, such as associating content items with certain types of ad campaigns. A content provider operating a content provider device may also access the product testing server 116 over the network 120 to access analytics data and product testing related data. Such analytics and product testing data may help focus developing content items, editing content items, deleting content items, setting and adjusting bid amounts, and activities related to distribution of the content. In other words, the analytics and product testing information may be used as feedback for developing and distribution of online products, such as for developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120. In editing the content data, adjustments to test variables and parameters may be determined and presented upon editing of the content data, so that a publisher can view how changes affect threshold metrics of a respective online product.

The content provider front end may be a client-side application. A script and/or applet and the script and/or applet may manage the retrieval of campaign data. In an example, this front end may include a graphical display of fields for selecting audience segments, segment combinations, or at least parts of campaigns. Then this front end, via the script and/or applet, can request data related to product testing from the product testing server 116. The information related to product testing can then be displayed, such as displayed according to the script and/or applet.

The content server 112 includes logic and data operative to format content data for communication to the audience device. The content server 112 can provide content items or links to such items to the analytics server 118 or the product testing server 116 to associate with product testing. For example, content items and links may be matched to such data. The matching may be complex and may be based on historical information related to testing of online products.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data and other information and data outputted by the content server may be logged in data logs. For example, content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a significance supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, FLICKER, TWITTER, FACEBOOK, LINKEDIN, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

A provider client device, which may be any one of the device 122-128, includes a data processing device that may access the information system 100 over the network 120. The provider client device is operative to interact over the network 120 with any of the servers or databases described herein. The provider client device may implement a client-side application for viewing electronic properties and submitting user requests. The provider client device may communicate data to the information system 100, including data defining electronic properties and other information. The provider client device may receive communications from the information system 100, including data defining electronic properties and advertising creatives. The aforementioned interactions and information may be logged in data logs.

In an example, content providers may access the information system 100 with content provider devices that are generally analogous to advertiser devices in structure and function. The content provider devices may provide access to content data in the content database 114, for example. The advertiser provider devices may provide access to ad data in the ad database 110.

An audience client device, which may be any of the devices 122-128, includes a data processing device that may access the information system 100 over the network 120. The audience client device is operative to interact over the network 120 with the search engine server 106, the ad server 108, the content server 112, the product testing server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs.

Provider client devices and audience client devices operate as client devices when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, FACEBOOK, LINKEDIN, TWITTER, FLICKR, OR GOOGLE+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs.

Also, the disclosed methods and systems may be implemented at least partially in a cloud-computing environment, at least partially in a server, at least partially in a client device, or in a combination thereof.

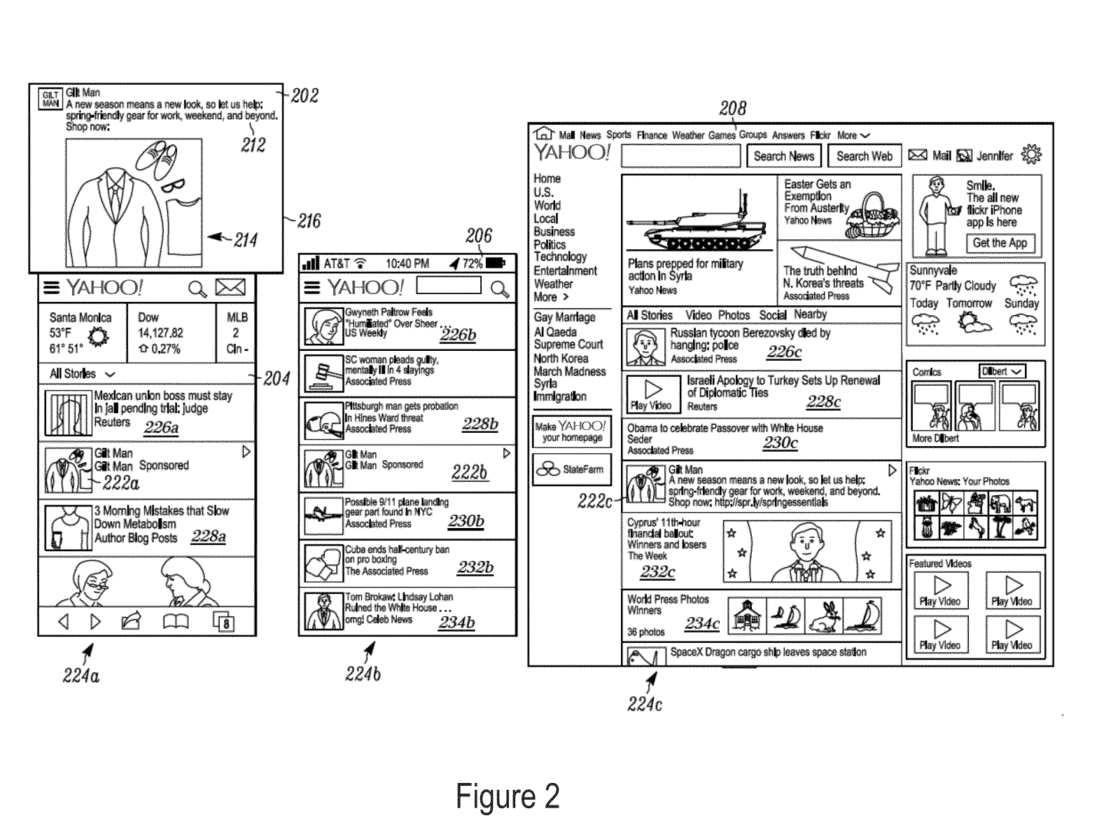

FIG. 2 illustrates displayed ad items and content items of example screens rendered by client-side applications. The content items and ad items displayed may be provided by the search engine server 106, the ad server 108, or the content server 112. User interactions with the ad items and content items can be tracked and logged in data logs, and the logs may be communicated to the analytics server 118 for processing. Once processed into corresponding analytics data, such data can be input for determining the minimum threshold value for a bucket test and other parameters of online product testing.

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the analytics server 118 for processing. Once processed into corresponding analytics data, such data can be input for determining the minimum threshold value and other parameters of online product testing.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Such interactions may be communicated to the analytics server 118; and once processed into corresponding analytics data, such data can be input for determining the minimum threshold value and other parameters of online product testing.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. Once processed into corresponding analytics data, such data can be input for determining the minimum threshold value and other parameters of online product testing.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. Once processed into corresponding analytics data, such data can be input for determining the minimum threshold value and other parameters of online product testing.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to online product testing data, such as the data used to determine a minimum threshold value for bucket testing.

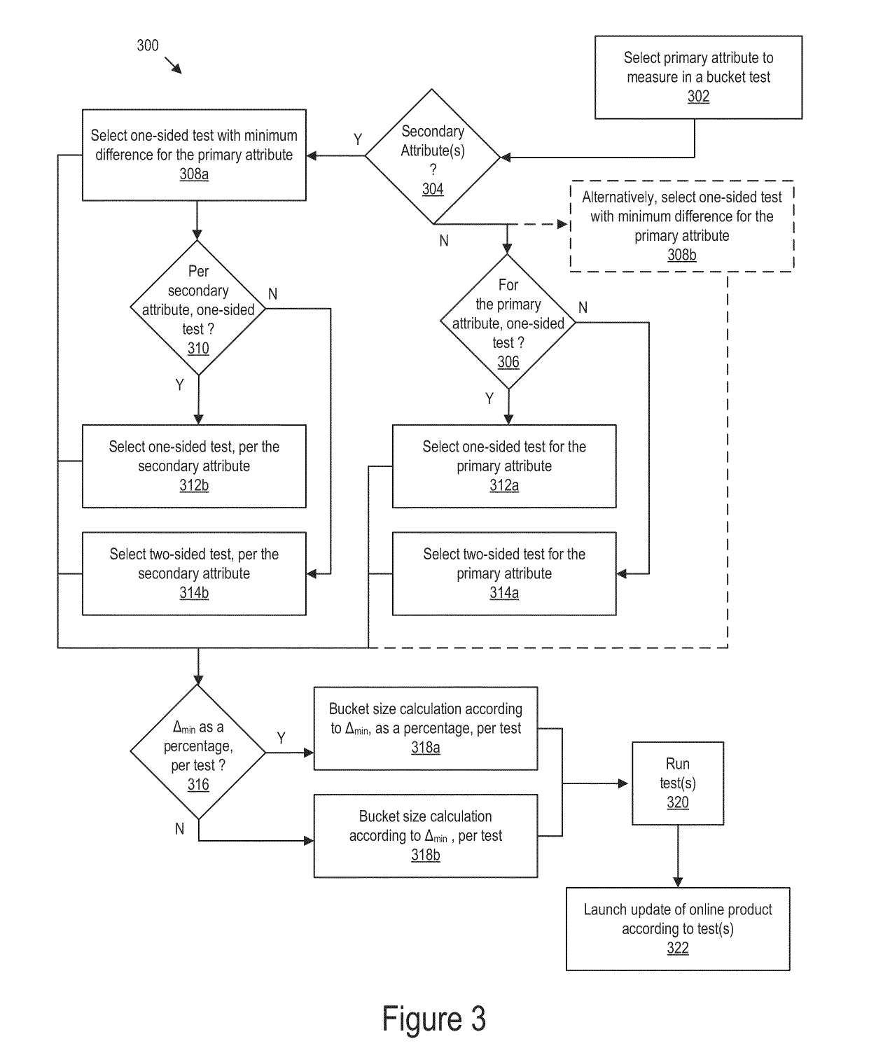

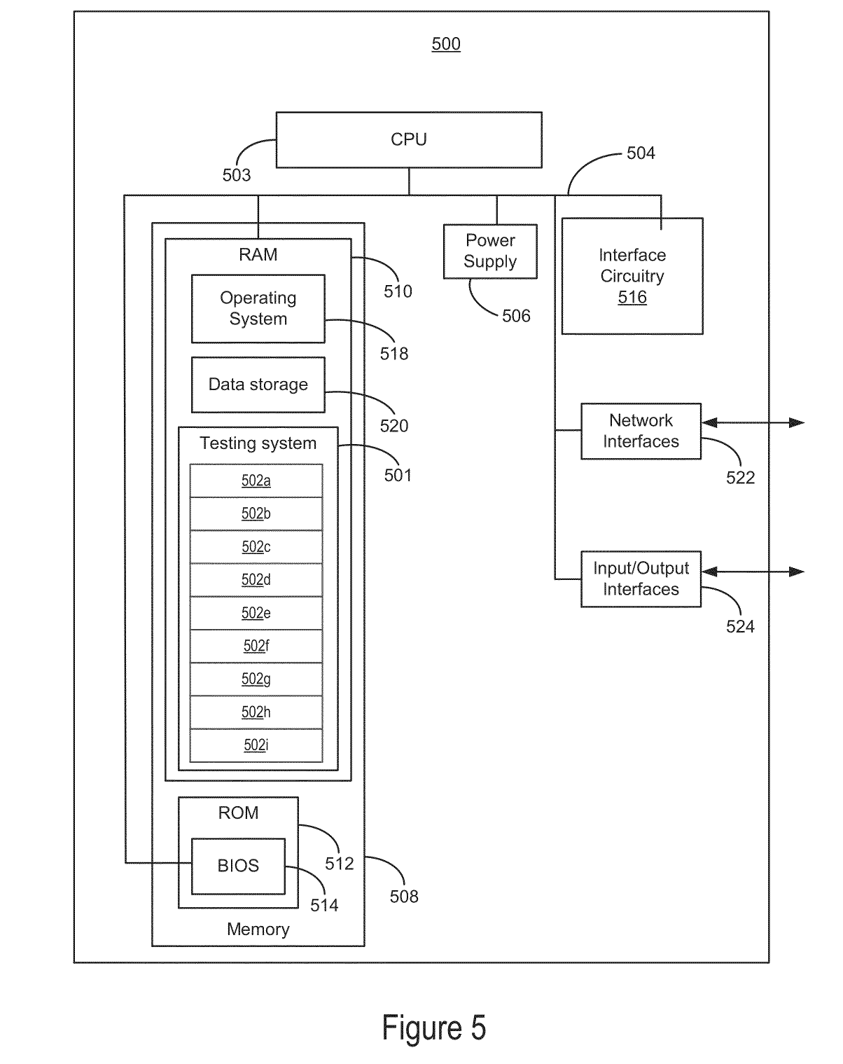

FIG. 3 illustrates example operations 300 performed by a testing system (such as the testing system 501 illustrated in FIG. 5). The testing system can be or include a product testing portion of the information system illustrated in FIG. 1, which can provide bucket testing of online product updates. The operations 300 can begin with an aspect of the testing system (such as the threshold metric circuitry 502a illustrated in FIG. 5) or an operator of the testing system selecting a primary attribute (e.g., a threshold metric) of an online product to measure in a bucket test, at 302. The primary attribute may be associated with performance of the online product. For example, the primary attribute may be a click-through rate or an impression rate associated with the online product. . . .

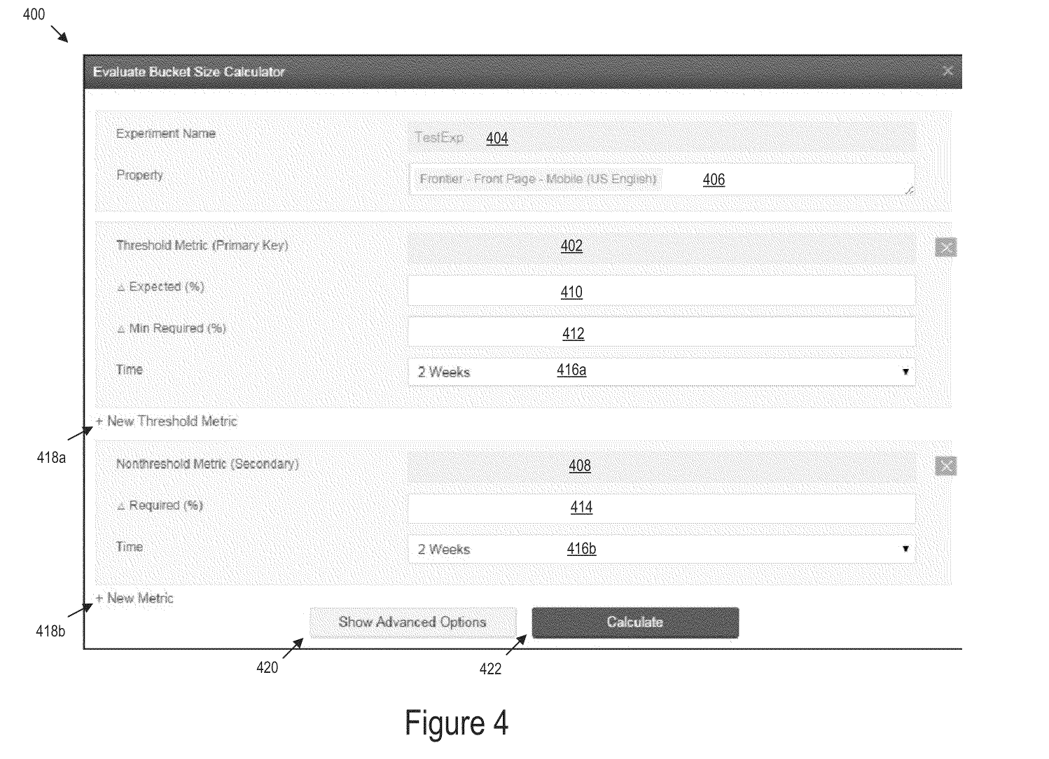

FIG. 4 illustrates a graphical user interface (GUI) 400 for setting and/or viewing parameters of an experiment associated with a launch of an update to an online product, such as setting and/or viewing a primary attribute for monitoring in a bucket test. Field 402 provides for setting and/or viewing a primary attribute. The experiment can include one or more bucket tests on different metrics. Parameters can include the primary attribute to measure in a bucket test selected at 302. Besides the primary attribute, any other parameter of a bucket test can be set and/or viewed through the GUI 400. For example, and as illustrated in FIG. 4, a name and/or unique identification of the bucket test can be entered and viewed at field 404. Also, a name and/or unique identification of the online product being tested can be entered and/or viewed at field 406. Also, threshold and non-threshold metrics can be entered and/or viewed at fields 402 and 408, respectively. An expected difference between the control and the update (Δ_{expected}) can be entered and/or viewed at field 410 and a minimum acceptable difference between the control and the update (Δₘᵢₙ) for a primary attribute can be entered and/or viewed at field 412. An acceptable difference between the control and the update for a secondary attribute (e.g., a non-threshold metric) can be entered and/or viewed at field 414. The threshold and non-threshold metrics can be used as primary keys and secondary keys for the experiment, respectively. Also, time periods to run the test(s) over can be entered and/or viewed at respective fields 416a and 416b. As illustrated in FIG. 4, respective GUI elements 418a and 418b can be included to add primary and secondary metrics for bucket testing. In other words, this GUI element can facilitate adding bucket tests to the experiment, such as adding additional bucket tests for additional secondary attributes. The GUI 400 also can provide a GUI element 420 for expanding the GUI to add additional parameters, such as parameters that usually have default values. Such default values can be static or dynamic, and can be manually or automatically updated or entered. The GUI element 422 can initiate bucket test calculations that use at least one or more of the aforementioned parameters.

Referring back to FIG. 3, the operations 300 can include an aspect of the testing system receiving a selection of at least one secondary attribute of the online product to measure in a bucket test. A secondary attribute may be a click-through rate or an impression rate associated with a different aspect of the online product.

At 304, an aspect of the testing system (such as non-threshold metric circuitry) or an operator of the testing system can determine whether the testing system tests a secondary attribute of the online product to measure in a bucket test. Where secondary attributes are not considered, the operations 300 can include an aspect of the testing system or an operator of the testing system determining whether the bucket test uses a one-sided test or a two-sided test, at 306.

In a bucket test, the testing system may define an average (such as a population mean) of a metric in a control bucket as μ₀ and the metric in a test bucket as μ₁. The testing system may define a standard two-sided test as: H₀:μ₁−μ₀=0, H₁:μ₁−μ₀≠0. After a bucket test, the testing system may reject H₀ if:

$$\frac{\vert {\overline{x}}_{1} - {\overline{x}}_{0} \vert}{\sqrt{\frac{1}{{n}_{1}} + \frac{1}{{n}_{0}}} \hat{σ}} > {Z}_{1 - α / 2} ,$$

where X̅₁, X̅₀ denotes a sample average of the metric in each bucket, n₁ and n₀ are sample sizes in each bucket, \hat{σ} is a common sample standard deviation of a threshold metric for the two samples, α is a significance level, and Z_{(1-α/2)} is a quantile of a standard normal distribution with respect to probability 1−α/2.

A two-sided confidence interval for μ₁−μ₀ can be

$$[ {x}_{1} - {x}_{0} ∓ {Z}_{( 1 - α / 2 )} \sqrt{\frac{1}{{n}_{1}} + \frac{1}{{n}_{0}}} \hat{σ} ] ,$$

which contains an underlying two-sided confidence interval for μ₁−μ₀ with probability 1−α. The testing system may reject the H₀ and report a significant difference between the two buckets if zero is beyond the boundary of the confidence interval.

The output p-value for this two-sided test can be:

$${p}_{2 s} = 2 [ 1 - Φ ( \frac{\vert {\overline{x}}_{1} - {\overline{x}}_{0} \vert}{\sqrt{\frac{1}{{n}_{1}} + \frac{1}{{n}_{0}}} \hat{σ}} ) ] ,$$

where Φ ( . . . ) denotes the cumulative distribution function for standard normal distribution.

The null may be rejected with a confidence level 1−α if the p-value is smaller than α.

The testing system may only consider one direction of the difference. In such a scenario, the testing system may use a one-sided test rather than a two-sided test, since a one-sided test may provide more statistical power. A standard one-sided test may have the hypothesis statement:

H₀:μ₁−μ₀≦0, H₁:μ₁−μ₀>0.

After the experiment, the testing system may reject H₀ if

$$\frac{{\overline{x}}_{1} - {\overline{x}}_{0}}{\sqrt{\frac{1}{{n}_{1}} + \frac{1}{{n}_{0}}} \hat{σ}} > {Z}_{1 - α} .$$

A one-sided confidence interval for μ₁−μ₀ may be

$${\overline{x}}_{1} - {\overline{x}}_{0} - {Z}_{1 - α} \sqrt{\frac{1}{{n}_{1}} + \frac{1}{{n}_{0}}} \hat{σ} , + ∞ .$$

The system may reject the H₀ and report significant lift brought by the new version of the product, if zero is smaller than the lower boundary of the confidence interval for the one-sided test. The one-sided test can be in the positive or negative direction. The output p-value for this one-sided test can be:

$${p}_{1 s} = 1 - Φ ( \frac{{\overline{x}}_{1} - {\overline{x}}_{0}}{\sqrt{\frac{1}{{n}_{1}} + \frac{1}{{n}_{0}}} \hat{σ}} ) .$$

The null value may be rejected with a confidence level 1−α if the p-value is smaller than α.

Referring back to the example of the testing of a larger search box on a webpage. This test may show a positive impact on the number of searches, but also may show a negative impact on navigational clicks to other properties. A decision to launch the new version of the search box may consider that such a negative impact is smaller than a certain amount, which may direct the hypotheses statement to take the opposite direction, such as:

H₀:μ₁−μ₀≧0, H₁:μ₁−μ₀<0.

Referring back to FIG. 3, where at least one secondary attribute is considered, the operations 300 can include an aspect of the testing system or an operator of the testing system selecting a one-sided test with minimum difference for the bucket test using the primary attribute as a measurement, at 308a. Alternatively or additionally, regardless of a secondary attribute being considered, the testing system may select a one-sided test with minimum difference for the bucket test using the primary attribute as a measurement, at 308b.

Standard bucket tests can have a limitation in that such tests can only inform a product team whether or not there is a significant difference between the two buckets, but not quantify this difference to show whether it is significantly greater than certain amount. Referring back to the example of the larger search box requiring a minimum lift in search traffic, the system may use the minimum threshold value (e.g., a predetermined minimum difference of the threshold metric) with a one-sided test, such that the testing system can test whether the difference between the buckets is greater than the minimum threshold value (such as an absolute value of the difference is greater than the predetermined minimum difference of the threshold metric). The minimum threshold value can be either positive or negative, depending on the business scenario. To illustrate the minimum threshold value conveniently, illustrated herein is a positive minimum difference (e.g., a minimum lift required of a threshold metric to reject the null hypothesis H₀).

To test whether a product update can cause a lift no less than a minimum lift (Δₘᵢₙ), the testing system may use the following one-sided test:

H₀:μ₁−μ₀≦Δₘᵢₙ, H₁:μ₁−μ₀>Δₘᵢₙ.

For this testing problem, if the outcome is significant, then the testing system can conclude that with a confidence level of 1−α, the new feature brings a significant lift which is greater than Δₘᵢₙ.

For this one-sided test, the testing system may reject H₀ if

$$\frac{{\overline{x}}_{1} - {\overline{x}}_{0} - {Δ}_{min}}{\sqrt{\frac{1}{{n}_{1}} + \frac{1}{{n}_{0}}} \hat{σ}} > {Z}_{1 - α} , \\ or$$

$${\overline{x}}_{1} - {\overline{x}}_{0} - {Z}_{1 - α} \sqrt{\frac{1}{{n}_{1}} + \frac{1}{{n}_{0}}} \hat{σ} > {Δ}_{min} .$$

The one-sided confidence interval for μ1−μ0 may be

$${\overline{x}}_{1} - {\overline{x}}_{0} - {Z}_{1 - α} \sqrt{\frac{1}{{n}_{1}} + \frac{1}{{n}_{0}}} \hat{σ} , + ∞ .$$

The testing system may reject the H₀ if the confidence interval is greater than Δₘᵢₙ. The output p-value for this one-sided test with minimum difference can be:

$${p}_{1 s - min} = 1 - Φ ( \frac{{\overline{x}}_{1} - {\overline{x}}_{0} - {Δ}_{min}}{\sqrt{\frac{1}{{n}_{1}} + \frac{1}{{n}_{0}}} \hat{σ}} ) ,$$

The null hypothesis may be rejected with a confidence level 1−α if the p-value is smaller than α.

Additionally, where at least one secondary attribute is considered, per secondary attribute, the operations 300 can include an aspect of the testing system or an operator of the testing system determining whether a respective bucket test uses a standard one-sided test or a standard two-sided test, at 310. In some examples, for different business scenarios and different metrics, the testing system may choose the standard one-sided test and/or the standard two-sided tests. For example, referring back to the example of the update of the larger search box on the webpage, a product team may want to monitor and consider several metrics. In such cases, there may be one metric that is of primary importance and a plurality of metrics of secondary importance. In such examples, the new version can be launched if: for the primary metric, there is a lift greater than a minimum lift Δₘᵢₙ or a minimum lift in percentage Δₘᵢₙ^{P} for the new version compared to the current version; and for secondary metrics, there is no statistically significant negative impact of the new version compared to the current version of the product. In this scenario, the testing system can run a one-sided test with minimum lift Δₘᵢₙ or a one-sided test with minimum lift in percentage Δₘᵢₙ^{P} for the primary metric, and two-sided tests for the secondary metrics.

Where it is determined that a secondary attribute is not considered at 304 and it is determined to use a one-sided test at 306, the operations 300 can include an aspect of the testing system or an operator of the testing system selecting a one-sided test for the bucket test using the primary attribute, at 312a. Where it is determined that a secondary attribute is considered at 304 and it is determined to use a one-sided test at 310, the operations 300 can include an aspect of the testing system or an operator of the testing system selecting a one-sided test for the bucket test using the secondary attribute, at 312b. Where it is determined that a secondary attribute is not considered at 304 and it is determined to use a two-sided test at 306, the operations 300 can include an aspect of the testing system or an operator of the testing system selecting a two-sided test for the bucket test using the primary attribute, at 314a. Where it is determined that a secondary attribute is considered at 304 and it is determined to use a two-sided test at 310, the operations 300 can include an aspect of the testing system or an operator of the testing system selecting a two-sided test for the bucket test using the secondary attribute, at 314b. Referring back to the illustrative example of the search box of a greater size, the respective product team of the webpage may plan to launch a new version of the page that contains more ads to increase revenue but considers user engagement such that the user engagement is not affected. In this scenario, the team could investigate the impact on user engagement metrics by either a two-sided test (to monitor whether there is significant change) or a one-sided test (to monitor whether there is significant negative impact). Also, the product team may be migrating the webpage from a current platform to a new platform and want to determine whether there may be significant change in user engagement metrics. In this scenario, they can do two-sided tests on a user engagement metric. If the product team has a directional assumption about the test, and they have a difference threshold for making decisions, then the one-sided test with minimum threshold value should be used on the metric. Also, a choice of specifying such a minimum difference as an absolute magnitude or a percentage may be considered. Such a choice may depend on the specific business use case and/or which is easier to specify. Otherwise, if the goal is to test whether there is a difference between different buckets, and a minimum difference is not considered, then a standard two-sided or one-sided test can be used.

In an example, once a bucket test is selected, such as per primary attribute and secondary attribute, an aspect of the testing system can determine whether to bucket test for Δ_{min,} as a percentage or not as a percentage, at 316. For example, in order to run a one-sided test with the minimum threshold value (e.g., the minimum difference of the primary attribute monitored), the testing system may specify the minimum difference Δₘᵢₙ as a percentage. For example, where the testing system does not have a scale of the primary attribute (such as the threshold metric), it may be impractical to derive an absolute number; and in such cases it may be more practical to specify the minimum difference as a percentage. In an example, this percentage may be a percentage relative to a metric average in the control bucket.

Where the difference as a percentage is defined as Δₘᵢₙ^{P}, the following one-sided test may be used.

H₀:μ₁−μ₀≦μ₀Δₘᵢₙ^{P}, H₁:μ₁−μ₀>μ₀Δₘᵢₙ^{P}

This test includes an unknown parameter μ₀ on the right hand side of the unequal sign. The testing system may not test the hypothesis above directly; instead, by moving μ₀ Δₘᵢₙ^{P} to the left side, the testing system may use the following formula.

H₀:μ₁−μ₀(1+Δₘᵢₙ^{P})≦0, H₁:μ₁−μ₀(1+Δₘᵢₙ^{P})>0

The test statistic may be

$$\frac{{\overline{x}}_{1} - {\overline{x}}_{0} ( 1 + {Δ}_{min}^{P} )}{\hat{σ} \sqrt{\frac{1}{{n}_{1}} + \frac{1}{{n}_{0}} {( 1 + {Δ}_{min}^{P} )}^{2}}} ,$$

and the testing system may reject H₀ if

$$\frac{{\overline{x}}_{1} - {\overline{x}}_{0} ( 1 + {Δ}_{min}^{P} )}{\hat{σ} \sqrt{\frac{1}{{n}_{1}} + \frac{1}{{n}_{0}} {( 1 + {Δ}_{min}^{P} )}^{2}}} > {Z}_{1 - α} .$$

In terms of confidence interval, this one-sided confidence interval for μ₁−μ₀ may be the same as a standard one-sided test:

$${\overline{x}}_{1} - {\overline{x}}_{0} - {Z}_{1 - α} \sqrt{\frac{1}{{n}_{1}} + \frac{1}{{n}_{0}}} \hat{σ} , + ∞ .$$

The testing system may reject H₀ if the lower limit of the confidence interval is greater than

$${\overline{x}}_{0} {Δ}_{min}^{P} + \hat{σ} {Z}_{1 - α} ( \sqrt{\frac{1}{{n}_{1}} + \frac{1}{{n}_{0}} {( 1 + {Δ}_{min}^{p} )}^{2}} - \sqrt{\frac{1}{{n}_{1}} + \frac{1}{{n}_{0}}} ) .$$

The p-value for the one-sided test with minimum difference in percentage will be:

$${p}_{1 s - minp} = 1 - Φ ( \frac{{\overline{x}}_{1} - {\overline{x}}_{0} ( 1 + {Δ}_{min}^{p} )}{\hat{σ} \sqrt{\frac{1}{{n}_{1}} + \frac{1}{{n}_{0}} {( 1 + {Δ}_{min}^{p} )}^{2}}} ) .$$

The null hypothesis may be rejected with a confidence 1−α if the p-value is smaller than α.

This test may provide a confidence level of 1−α, whether or not the test version is significantly different from the control version by a percentage (Δₘᵢₙ^{P}). This test is created to provide convenience for product testing teams. Also, this test may change the test statistic, a rejection region, and a sample size calculation. Also, where the null is rejected for this one-sided test with minimum difference in percentage, it can be shown that the lower bound of the confidence level of the difference μ₁−μ₀ is greater than \hat{μ}₀Δₘᵢₙ^{P}= x̅₁Δₘᵢₙ^{P}.

Additionally or alternatively, an aspect of the testing system (such as the control circuitry 502d illustrated in FIG. 5) can calculate a sample size for a selected bucket test. For example, at 318, according to the determination at 316, the aspect can calculate a sample size for Δ_{min,} as a percentage (at 318a) or not as a percentage (at 318b). As illustrated in FIG. 3, subsequent to choosing the test(s), and prior to running the test(s), the testing system may calculate the sample size for each bucket in order to provide sufficient statistical power for a test.

A goal of the testing system may be to to calculate a bucket size for the adapted one-sided test, such that where there is an expected difference (e.g., μ₁−μ₀=Δ_{expected}) not consistent with the null hypothesis, the outcome of the test rejects H₀ with a probability equal to a predetermined significance. For example, where:

H₀:μ₁−μ₀≦Δₘᵢₙ, H₁:μ₁−μ₀>Δₘᵢₙ,

the sample size needed for each bucket (assuming an equal size for each bucket) can be

$$n = \frac{2 {{σ}^{2} ( {Z}_{1 - β} + {Z}_{1 - α} )}^{2}}{{( Δ - {Δ}_{min} )}^{2}} ,$$

where σ is the standard deviation for the metric, β is a pre-specified Type II error and 1−β is a desired significance, Z_{(1-β)} is a standard normal distribution quantile at 1−β, and Δ is expected difference of the new version compared to the current version (e.g., Δ_{expected}).

Where it is more practical to specify the minimum difference as a percentage, such that the testing system defines Δₘᵢₙ as Δₘᵢₙ=μ₀Δₘᵢₙ^{P}, the system may let the experiment owner specify an expected difference in percentage (such as with respect to a historical average of the threshold metric), denoted as Δ^{P}, and Δ=μ₀Δ^{P}. Since the minimum difference is no longer an absolute magnitude, the sample size calculation also changes. In this case, the sample size formula is defined as:

$$n = \frac{[ 1 + {( 1 + {Δ}_{min}^{P} )}^{2} ] {{σ}^{2} ( {Z}_{1 - α} + {Z}_{1 - β} )}^{2}}{{{μ}_{0}^{2} ( {Δ}^{p} - {Δ}_{min}^{P} )}^{2}} .$$

The testing system can also determine sample size for standard two-sided and one-sided tests. For a standard two-sided test: H₀:μ₁−μ₀=0, H₁:μ₁−μ₀≠0, the sample size (assuming an equal size for each bucket) can be:

$$n = \frac{2 {{σ}^{2} ( {Z}_{1 - β} + {Z}_{1 - α / 2} )}^{2}}{{Δ}^{2}} .$$

For a standard one-sided test: H₀:μ₁−μ₀≦0, H₁:μ₁−μ22 0, the sample size (assuming an equal size for each bucket) can be:

$$n = \frac{2 {σ}^{2} ( {Z}_{1 - β} ) + {( {Z}_{1 - α} )}^{2}}{{Δ}^{2}}$$

There are multiple parameters in these sample size formulas. Both the one and two-sided tests may use larger sample sizes (i.e. larger buckets) if, the ratio between σ/μ₀ increases, the required level of significance 1−β increases, or the testing system may use a more stringent threshold for significance (i.e., decreasing α). For the one-sided test, a larger sample size may be used if the difference between the expected and minimum difference Δ−Δₘᵢₙ or Δ^{P}−Δₘᵢₙ^{P} decreases. Finally, specifically for a two-sided test, the sample size may increase as the expected difference Δ or Δ^{P} decreases.

In examples, the testing system may specify some parameters in the sample size calculations, and some parameters may be specified by the experiment owner. Some parameters may be specified using default values according to industry standards and others may be estimated by historical data (such as historical analytics data stored in the analytics database 119 illustrated in FIG. 1).

Both the expected difference Δ^{P} and minimum difference Δₘᵢₙ^{P} be set by an experiment owner. Alternatively, determination of these parameters may be the testing system using historical data (such as analytics data stored in the analytics database 119 illustrated in FIG. 1). Both parameters should be carefully considered; otherwise, for the expected difference Δ^{P}, a mismatched and overestimation may result in a sample size that is too small. Such a scenario may not provide sufficient statistical power to detect the difference between the versions of the product. On the other hand, a mismatch and underestimation can result in a sample size that is too large, which may deliver the new version to an undesirable amount of users. Regarding the minimum difference Δₘᵢₙ^{P}, this parameter may be selected according to historical data as well, such as historical revenue data. If the new version requires a large difference to launch, then Aₘᵢₙ^{P} should be relatively large; otherwise, if only a small difference is enough to launch the product, then Δₘᵢₙ^{P} can be a smaller value.

α and β may be industry standard values. Significance, 1−β, and significance threshold, α, may be fixed values for most experiments. As a consequence, the corresponding standard normal quantiles may also be fixed.

The average (e.g., mean) and standard deviation, \hat{μ}₀ and \hat{σ}, respectively, of a metric may vary across different products and updates. These values may be estimated using historical data for a product being tested (such as historical analytics data stored in the analytics database 119). In an example, these parameters may depend on the period of the test. In such an example, the historical data used for estimation should have occurred over at least the same amount of time of the duration of the experiment.

At 320, an aspect of the testing system (such as the test-running circuitry 502f illustrated in FIG. 5) can run the test(s) selected in the operations 300. At 322, an aspect of the testing system (such as the launch circuitry 502e illustrated in FIG. 5) can launch the tested update of the online product according to the test(s). For example, the testing system can test changes to an element of a web property, such as increasing the size of a search box on a portal webpage with a goal of boosting the number of searches originating on the webpage. A product team may consider launching a change to a selected number of users (such as all users), if a certain performance measurement is increased by a preset minimum amount based on revenue generating impact associated with the performance measurement (such as if the number of searches per cookie or visit to the page is increased by a certain percentage). If the change does not provide a lift greater than the preset minimum amount of lift to the performance measurement, the team may discard the update.

As mentioned, for the sake of simplicity, the description herein assumes equal bucket sizes in a bucket test. However, this system can also support unequal bucket size design. Below is a formula for sample size calculation based on unequal sample sizes. n₁ defines the sample size in the test bucket and n₀ defines the sample size in the control bucket. Assuming n₁=rn₀, the sample sizes for a one-sided test with minimum difference can be calculated using:

$${n}_{0} = \frac{r + 1}{r} \frac{{{σ}^{2} ( {Z}_{1 - β} + {Z}_{1 - α} )}^{2}}{{{μ}_{0}^{2} ( {Δ}^{p} - {Δ}_{min}^{P} )}^{2}}$$

$${n}_{1} = {rn}_{0} = ( r + 1 ) \frac{{{σ}^{2} ( {Z}_{1 - β} + {Z}_{1 - α} )}^{2}}{{{μ}_{0}^{2} ( {Δ}^{p} - {Δ}_{min}^{P} )}^{2}}$$

For one-sided test with minimum difference as a percentage, the sample sizes can be calculated using:

$${n}_{0} = \frac{[ 1 + {r ( 1 + {Δ}_{min}^{P} )}^{2} ] {{σ}^{2} ( {Z}_{1 - α} + {Z}_{1 - β} )}^{2}}{r {{μ}_{0}^{2} ( {Δ}^{p} - {Δ}_{min}^{P} )}^{2}}$$

$${n}_{1} = {rn}_{0} = \frac{[ 1 + {r ( 1 + {Δ}_{min}^{P} )}^{2} ] {{σ}^{2} ( {Z}_{1 - α} + {Z}_{1 - β} )}^{2}}{{{μ}_{0}^{2} ( {Δ}^{p} - {Δ}_{min}^{P} )}^{2}}$$

FIG. 5 is a block diagram of an example electronic device 500, such as a server, that can implement aspects of and related to an example product testing system 501, such as a bucket testing system of the product testing server 116. The product testing system 501 can be testing circuitry, such as bucket testing circuitry. The testing system 501 can include threshold metric circuitry 502a, minimum difference circuitry 502b, confidence circuitry 502c, control circuitry 502d, launch circuitry 502e, test-running circuitry 502f, secondary difference circuitry 502g, metric generation circuitry 502h, and graphical user interface (GUI) circuitry 502i.

The threshold metric circuitry 502a can store a threshold metric of a bucket test of an update to an online product. The threshold metric can include a software metric associated with the online product. Also, the bucket test can include an A/B test. Additionally, the threshold metric can be a primary metric and the software metric can be a primary software metric.

The minimum difference circuitry 502b can store a predetermined minimum difference of the threshold metric. The confidence circuitry 502c can store a confidence interval (such as for a difference of the mean), a p-value, and a test conclusion (whether H₀ is rejected or not) of the threshold metric. The confidence interval can be a minimum confidence interval. The control circuitry 502d can store a control metric of the bucket test. The control metric can be a bucket size of the bucket test and/or a time period of the bucket test. The launch circuitry 502e can provide the update to the online product where test conclusion indicates that with pre-specified confidence a resulting difference of the bucket test is greater than the predetermined minimum difference. The test-running circuitry 502f can run the bucket test according to the control metric.

In an example, the testing system 501 can further include non-threshold metric circuitry (not depicted) that can store a secondary metric. The secondary metric can be a secondary software metric. Also, in such an example, the test system 501 can include secondary difference circuitry 502g that can store a required difference associated with the secondary metric. Also, in such an example, the control circuitry 502d can also store a control metric of the bucket test associated with the secondary metric. Likewise, in such an example, the bucket test may be a first bucket test and the control metric may be a bucket size of a second bucket test associated with the secondary metric and/or a second time period associated with the second bucket test.

The GUI circuitry 502i can provide at least one GUI (such as GUI 400 in FIG. 4). A GUI in such a system can include respective fields that can display the threshold metric, the predetermined minimum difference, and the confidence interval. Also, the GUI can display the confidence interval, the p-value, and the test conclusion. Also, the GUI can include a dashboard; and in the dashboard, the respective fields can update in real time during a bucket test. Also, the metric generation circuitry 502h can generate an additional metric, and the GUI can further include a respective field that can initiate the generation of the additional metric.

The electronic device 500 can also include a CPU 503, memory 510, a power supply 506, and input/output components, such as network interfaces 530 and input/output interfaces 540, and a communication bus 504 that connects the aforementioned elements of the electronic device. The network interfaces 530 can include a receiver and a transmitter (or a transceiver), and an antenna for wireless communications. The network interfaces 530 can also include at least part of the interface circuitry 516. The CPU 503 can be any type of data processing device, such as a central processing unit (CPU). Also, for example, the CPU 503 can be central processing logic.

The memory 510, which can include random access memory (RAM) 512 or read-only memory (ROM) 514, can be enabled by memory devices. The RAM 512 can store data and instructions defining an operating system 521, data storage 524, and the product testing system 501, which can be implemented through hardware such as a microprocessor and/or circuitry (e.g., circuitry including circuitries 502a-502i). In another example, the product testing system 501 may include firmware or software. The ROM 514 can include basic input/output system (BIOS) 515 of the electronic device 500. The memory 510 may include a non-transitory medium executable by the CPU.

The power supply 506 contains power components, and facilitates supply and management of power to the electronic device 500. The input/output components can include at least part of the interface circuitry 516 for facilitating communication between any components of the electronic device 500, components of external devices (such as components of other devices of the information system 100), and end users. For example, such components can include a network card that is an integration of a receiver, a transmitter, and I/O interfaces, such as input/output interfaces 540. The I/O components, such as I/O interfaces 540, can include user interfaces such as monitors, keyboards, touchscreens, microphones, and speakers. Further, some of the I/O components, such as I/O interfaces 540, and the bus 504 can facilitate communication between components of the electronic device 500, and can ease processing performed by the CPU 503.

The electronic device 500 can send and receive signals, such as via a wired or wireless network, or may be capable of processing or storing signals, such as in memory as physical memory states, and may, therefore, operate as a server. The device 500 can include a single server, dedicated rack-mounted servers, desktop computers, laptop computers, set top boxes, integrated devices combining various features, such as two or more features of the foregoing devices, or the like.

1. Testing circuitry for bucket testing, comprising:
threshold metric circuitry configured to store a threshold metric of a bucket test of an update to an online product, wherein the threshold metric includes a software metric associated with the online product;
minimum difference circuitry configured to store a predetermined minimum difference of the threshold metric; and
confidence circuitry configured to store a confidence interval, a p-value, a test conclusion, or any combination thereof of the threshold metric.

2. The testing circuitry of claim 1, further comprising control circuitry configured to store a control metric of the bucket test.

3. The testing circuitry of claim 2, further comprising launch circuitry configured to provide the update to the online product where the test conclusion indicates that with pre-specified confidence a resulting difference of the bucket test is greater than the predetermined minimum difference.

4. The testing circuitry of claim 2, further comprising test-running circuitry configured to run the bucket test according to the control metric.

5. The testing circuitry of claim 2, wherein the control metric is a bucket size of the bucket test.

6. The testing circuitry of claim 2, wherein the control metric is a time period of the bucket test.

7. The testing circuitry of claim 1, wherein the bucket test includes an A/B test.

8. The testing circuitry of claim 1, wherein the threshold metric is a primary metric, wherein the software metric is a primary software metric, wherein the testing circuitry further comprises non-threshold metric circuitry configured to store a secondary metric, and wherein the secondary metric is a secondary software metric.

9. The testing circuitry of claim 8, further comprising secondary difference circuitry configured to store a difference associated with the secondary metric.

10. The testing circuitry of claim 8, further comprising control circuitry configured to store a control metric of the bucket test associated with the secondary metric.

11. The testing circuitry of claim 10, wherein the bucket test is a first bucket test, and wherein the control metric is a bucket size of a second bucket test associated with the secondary metric.

12. The testing circuitry of claim 10, wherein the control metric is a time period of the bucket test.

13. The testing circuitry of claim 1, further comprising a graphical user interface (GUI), and wherein the GUI includes respective fields configured to display the threshold metric, the predetermined minimum difference, the confidence interval, the p-value, the test conclusion, or any combination thereof.

14. The testing circuitry of claim 13, wherein the GUI includes a dashboard, and wherein the respective fields update in real time during the bucket test.

15. The testing circuitry of claim 13, further comprising metric generation circuitry configured to generate an additional metric, and wherein the GUI further includes a graphical field configured to initiate the generation of the additional metric.

16. A method, comprising:
storing, in threshold metric circuitry, a threshold metric of a bucket test of an update to an online product, wherein the threshold metric includes a software metric associated with the online product;
storing, in minimum difference circuitry, a predetermined minimum difference of the threshold metric;
storing, in control circuitry, a control metric;
running, by test-running circuitry, a one-sided bucket test using the threshold metric, the predetermine minimum difference, and the control metric, which results in a test conclusion;
storing, by confidence circuitry, the test conclusion; and
providing, by launch circuitry, the update to the online product.

17. The method of claim 16, wherein the control metric is a bucket size of the bucket test.

18. The method of claim 16, wherein the control metric is a time period of the bucket test.

19. A method, comprising:
selecting, by bucket testing circuitry, a primary attribute according to analytics;
determining, by the circuitry, whether to consider a secondary attribute according to the analytics;
selecting, by the circuitry, a one-sided test with a minimum difference for the primary attribute according to the determination of whether to consider the secondary attribute; and
running, by the circuitry, the one-sided test with the minimum difference using the primary attribute as a threshold metric.

20. The method of claim 19, further comprising:
selecting, by the circuitry, the secondary attribute according to the analytics;
selecting, by the circuitry, a standard one-sided test or a standard two-sided test for the secondary attribute; and
running, by the circuitry, the standard one-sided test or the standard two-sided test accordingly, using the secondary attribute as a non-threshold metric.
